(19) United States
(12) Patent Application Publication
(10) Pub. No.: US 2016/0106108 A1
(43) Pub. Date: Apr. 21, 2016

(54) METHOD FOR PRODUCING A DOPED OR UNDOPED MIXED OXIDE FOR A COMPOSITE MATERIAL, AND A COMPOSITE MATERIAL COMPRISING SUCH A MIXED OXIDE

(71) Applicant: AMISTEC GMBH & CO. KG, Kössen in Tirol (AT)

(72) Inventors: Hans-Joachim Lunk, Towanda, PA (US); Joseph-Peter Guggenbichler, Kössen (AT)

(73) Assignee: AMISTEC GMBH & CO. KG, Kössen in Tirol (AT)

(21) Appl. No.: 14/787,094

(22) PCT Filed: Apr. 25, 2014
(86) PCT No.: PCT/EP2014/058472

§ 371 Date: Oct. 26, 2015

(30) Foreign Application Priority Data
Apr. 26, 2013 (DE) 10 2013 104 284.8

(51) Int. Cl. A01N 59/16; A01N 59/20

(52) U.S. Cl. CPC A01N 59/16; A01N 59/20

(57) ABSTRACT

The invention relates to a method for producing a doped or undoped mixed oxide for a composite material, wherein the mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺. Within the scope of the method, at least the steps of dissolving and/or suspending at least one molybdenum compound and at least one tungsten compound in at least one liquid medium, mixing the at least one molybdenum compound and the at least one tungsten compound in a predetermined mass ratio and drying the mixture of the at least one molybdenum compound and the at least one tungsten compound are performed. Furthermore, the invention relates to a composite material for producing antimicrobially effective surfaces containing at least one mixed oxide of the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺.

The invention relates to a method for producing a doped or undoped mixed oxide for a composite material, a composite material with such a mixed oxide as well as uses of the mixed oxide and the composite material.

From WO 2008/058707 A2, the use of molybdenum oxides such as for example MoO₂ and MoO₃ as well as of tungsten oxides such as for example WO₂ and WO₃ for producing composite materials as well as for aseptic configuration of surfaces is known. Molybdenum and tungsten oxides at least partially convert to molybdic and tungstic acids, respectively, upon contact with water such that an acidic surface pH value is formed, which generates an antimicrobial effect similar to the protective acid mantle of the skin. Therein, the use of molybdenum oxides or tungsten oxides is superior to the use of other antimicrobially effective substances such as for example nanosilver or organic biocides since inactivation of the antimicrobial efficiency by sweat or proteins does not occur among other things. Furthermore, the mentioned oxides are temperature stable and thereby also suitable for antimicrobial configuration of plastics, ceramics, metals and the like. Finally, molybdenum and tungsten oxides have a low toxicity as well as good skin and mucosa compatibility.

It is the object of the present invention to allow a further improved antimicrobial configuration of items.

According to the invention, the object is solved by a method according to claim 1 for producing a doped or undoped mixed oxide for a composite material, a composite material according to claim 9 for producing antimicrobially effective surfaces as well as by a use specified in claim 17 of such a composite material or at least one doped and/or undoped mixed oxide for producing an item with an antimicrobially effective surface. Advantageous configurations with convenient developments of the invention are specified in the respective dependent claims, wherein advantageous configurations of the method are to be regarded as advantageous configurations of the composite material and vice versa.

A first aspect of the invention relates to a method, in which a doped or undoped mixed oxide for a composite material is produced, wherein the mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺. Therein, the method according to the invention includes at least the steps of dissolving and/or suspending at least one molybdenum compound and at least one tungsten compound in at least one liquid medium, mixing the at least one molybdenum compound and the at least one tungsten compound in a predetermined mass ratio and drying the mixture of the at least one molybdenum compound and the at least one tungsten compound. Within the scope of the present invention, “solid solutions” of oxidic compounds are understood by a mixed oxide, which contain at least molybdenum and tungsten in the above mentioned molar ratios. Therein, the parameter x can basically take values greater than 0 and less than 1, thus for example 0.001, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99 as well as corresponding intermediate values. Basically, the parameter y can take values between 0 inclusive and 2 inclusive, thus for example 0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80, 1.81, 1.82, 1.83, 1.84, 1.85, 1.86, 1.87, 1.88, 1.89, 1.90, 1.91, 1.92, 1.93, 1.94, 1.95, 1.96, 1.97, 1.98, 1.99 or 2.00 as well as corresponding intermediate values. Basically, the parameter z can take values between 2.0 inclusive and 3.0 inclusive, thus for example 2.00, 2.01, 2.02, 2.03, 2.04, 2.05, 2.06, 2.07, 2.08, 2.09, 2.10, 2.11, 2.12, 2.13, 2.14, 2.15, 2.16, 2.17, 2.18, 2.19, 2.20, 2.21, 2.22, 2.23, 2.24, 2.25, 2.26, 2.27, 2.28, 2.29, 2.30, 2.31, 2.32, 2.33, 2.34, 2.35, 2.36, 2.37, 2.38, 2.39, 2.40, 2.41, 2.42, 2.43, 2.44, 2.45, 2.46, 2.47, 2.48, 2.49, 2.50, 2.51, 2.52, 2.53, 2.54, 2.55, 2.56, 2.57, 2.58, 2.59, 2.60, 2.61, 2.62, 2.63, 2.64, 2.65, 2.66, 2.67, 2.68, 2.69, 2.70, 2.71, 2.72, 2.73, 2.74, 2.75, 2.76, 2.77, 2.78, 2.79, 2.80, 2.81, 2.82, 2.83, 2.84, 2.85, 2.86, 2.87, 2.88, 2.89, 2.90, 2.91, 2.92, 2.93, 2.94, 2.95, 2.96, 2.97, 2.98, 2.99 or 3.00 as well as corresponding intermediate values. The production of such mixed oxides is in particular possible due to the similar atomic radii of molybdenum and tungsten. The inventors have ascertained that the antimicrobial efficiency of such mixed oxides is more pronounced than a purely additive effect of mixtures of molybdenum oxide and tungsten oxides would explain. Moreover, the mixed oxides produced according to the invention have a considerably lower water solubility than the corresponding molybdenum and tungsten oxides, whereby their antimicrobial effect is particularly long maintained even in wet environments as well as in applications under water. Depending on the used molybdenum and tungsten compounds, such mixed oxides are produced in simplest configuration in that corresponding solutions and/or suspensions of the corresponding molybdenum and tungsten compound(s) are first produced. Therein, the solutions and suspensions, respectively, can basically be produced separately from each other. Alternatively or additionally, in a single solution/suspension, multiple or all of the used molybdenum and/or tungsten compounds can be contained. Within the scope of the invention, pure substances or pure substance mixtures are to be understood by a liquid medium, which are liquid at least under SATP conditions (Standard Ambient Temperature and Pressure, T=298.15 K (25° C.), p=101,300 Pa). Mixing the used molybdenum and tungsten compounds can also be effected at the same time with the production of the solution/suspension, for example by collectively placing the used molybdenum and tungsten compounds in a corresponding container with the liquid medium. Alternatively or additionally, first, solutions/suspensions of individual or multiple molybdenum and/or tungsten compounds can be produced and subsequently be mixed with each other in the desired ratio to adjust the desired mass or molar ratio of the individual components. Depending on the configuration of the component M, which denotes at least one metal ion different from Mo and W and/or NH₄⁺, molybdenum and/or tungsten compounds can be basically used, which already contain the component M. Alternatively or additionally, one or more further compounds can be added to the solution(s)/suspension(s), which provide the component M. Subsequently, the liquid medium is removed, whereby the mixed oxide of the mentioned chemical formula MoₓW₁₋ₓM_{y}O_{z} is obtainable or is obtained. In the simplest configuration, the mixed oxide can only contain Mo, W, O and optionally voids or vacancies in the crystal lattice and be undoped. Alternatively, the mixed oxide can be doped. Within the scope of the present invention, the introduction of foreign atoms into the mixed oxide is understood by doping, wherein all of the foreign atoms together constitute maximally 10 mole-% of the mixed oxide, thus for example 10.0 mole-%, 9.9 mole-%, 9.8 mole-%, 9.7 mole-%, 9.6 mole-%, 9.5 mole-%, 9.4 mole-%, 9.3 mole-%, 9.2 mole-%, 9.1 mole-%, 9.0 mole-%, 8.9 mole-%, 8.8 mole-%, 8.7 mole-%, 8.6 mole-%, 8.5 mole-%, 8.4 mole-%, 8.3 mole-%, 8.2 mole-%, 8.1 mole-%, 8.0 mole-%, 7.9 mole-%, 7.8 mole-%, 7.7 mole-%, 7.6 mole-%, 7.5 mole-%, 7.4 mole-%, 7.3 mole-%, 7.2 mole-%, 7.1 mole-%, 7.0 mole-%, 6.9 mole-%, 6.8 mole-%, 6.7 mole-%, 6.6 mole-%, 6.5 mole-%, 6.4 mole-%, 6.3 mole-%, 6.2 mole-%, 6.1 mole-%, 6.0 mole-%, 5.9 mole-%, 5.8 mole-%, 5.7 mole-%, 5.6 mole-%, 5.5 mole-%, 5.4 mole-%, 5.3 mole-%, 5.2 mole-%, 5.1 mole-%, 5.0 mole-%, 4.9 mole-%, 4.8 mole-%, 4.7 mole-%, 4.6 mole-%, 4.5 mole-%, 4.4 mole-%, 4.3 mole-%, 4.2 mole-%, 4.1 mole-%, 4.0 mole-%, 3.9 mole-%, 3.8 mole-%, 3.7 mole-%, 3.6 mole-%, 3.5 mole-%, 3.4 mole-%, 3.3 mole-%, 3.2 mole-%, 3.1 mole-%, 3.0 mole-%, 2.9 mole-%, 2.8 mole-%, 2.7 mole-%, 2.6 mole-%, 2.5 mole-%, 2.4 mole-%, 2.3 mole-%, 2.2 mole-%, 2.1 mole-%, 2.0 mole-%, 1.9 mole-%, 1.8 mole-%, 1.7 mole-%, 1.6 mole-%, 1.5 mole-%, 1.4 mole-%, 1.3 mole-%, 1.2 mole-%, 1.1 mole-%, 1.0 mole-%, 0.9 mole-%, 0.8 mole-%, 0.7 mole-%, 0.6 mole-%, 0.5 mole-%, 0.4 mole-%, 0.3 mole-%, 0.2 mole-%, 0.1 mole-% or 0 mole-%. As already mentioned, the mixed oxide produced according to the invention can also contain one or more metal ions different from Mo and W and/or ammonium ions within the bounds defined by y besides Mo, W and O. Furthermore, it can be provided that multiple different mixed oxides or a heterogeneous mixed oxide with components varying within the specified chemical formula are produced within the scope of the method according to the invention.

In an advantageous configuration of the invention, it is provided that the at least one molybdenum compound is selected from a group including ammonium dimolybdate ((NH₄)₂Mo₂O₇, ADM), ammonium paramolybdate (APM), ammonium pentamolybdate, ammonium heptamolybdate, molybdenic acid, molybdenum oxide hydrate, molybdenum oxide, molybdenum suboxide, metallic molybdenum and polyoxomolybdate and/or that the at least one tungsten compound is selected from a group including ammonium metatungstates ((NH₄)₆[α-H₂W₁₂O₄₀]*3 H₂O, AMT), tungstic acid, tungsten oxide hydrates, tungsten oxide, tungsten suboxide, metallic tungsten and polyoxotungstates. By use of one or more of the mentioned compounds it is possible to produce the mixed oxide in particularly fast, simple manner and with a particularly precise composition. The use of one or more of the mentioned compounds offers the additional advantage that high oxide formation is ensured and thus the mixed oxide is obtained with particularly high yields.

Further advantages arise if M is selected from the group of Na, Cu, Bi, V, Ti and Zn and/or if the mixed oxide is doped with a fluorine compound, in particular with an oxyfluoride, WOF₄, WO₂F₂, calcium fluoride and/or fluorapatite. In the case of Na, Zn, Bi, Cu, Ti and V, the use of corresponding metal salts is particularly advantageous. The nitrate salts of the mentioned elements are particularly preferred because a disturbing anion (e.g. Cl⁻, SO4²⁻ etc.) does not remain as soon as the material has been dried (calcinated). However, it is also possible to use pure metals, alloys or the oxides thereof, preferably as a fine powder. Doping, that is the addition of foreign atoms, which do not come within the definition of the parameter M, with a fluorine compound offers the additional advantage that adhesion of microorganisms to the surface of the mixed oxide is additionally impeded. Thus, this prevents the colonization of surfaces provided with the mixed oxide and thereby additionally improves the antimicrobial effect. Herein, fluorine compounds with a water solubility as low as possible are preferably used to prevent or at least decelerate elution. Non-conclusive examples for suitable compounds are calcium fluoride (CaF₂) and fluorapatite (Ca₅[F|PO₄)₃]). The use of WOF₄, WO₂F₂ and/or corresponding molybdenum oxyfluorides offers the additional advantage that they contribute to the production of the mixed oxide and to the doping thereof with fluoride ions or fluorine compounds at the same time. Instead of or in addition to the doping of the mixed oxides with Na, Zn, Bi, Cu, Ti and V, it is basically possible to employ oxides or Zn, Bi, Cu, Ti and/or V together with one or more mixed oxides, in particular the compounds TiO₂, ZnO and V₂O₅.

In a further advantageous configuration of the invention, it is provided that the liquid medium is selected from a group including nonpolar and/or polar and/or protic and/or aprotic solvents. Thereby, the liquid medium can be optimally adapted to the respectively used molybdenum and/or tungsten compounds. Basically, for example polar protic or aprotic media such as water, acetonitrile or alcohols are suitable. Especially methyl alcohols have proven particularly advantageous. But nonpolar hydrocarbons are also basically suitable and can be particularly simply again extracted or removed.

In a further advantageous configuration of the invention, it is provided that solutions and/or suspensions of the at least one molybdenum compound and the at least one tungsten compound are dried with the aid of at least one method from the group of spray drying, freeze drying, combustion synthesis, flame hydrolysis, gaseous phase synthesis and/or spray pyrolysis. The solution(s)/suspension(s) can for example be atomized. However, some starting materials form a turbidity or a precipitation, for example zinc nitrate and ADM, in combining their solutions. In such a case, separate atomization of these substances is to be preferred. However, the formation of the mixed oxides can basically be effected according to different methods. Spray drying is particularly advantageous. Freeze drying has also proven itself. The methods of combustion synthesis, flame hydrolysis, gaseous phase synthesis and spray pyrolysis are also possible. Flame-based methods have the advantage of producing particularly fine particles, which can have average grain sizes in the range up to few nm. Therein, hydrocarbons used for suspension of the precursor substances can be advantageously used as energy carriers. The mixed oxide or the mixed oxides arise in different grain size distribution and with different residual humidity values according to drying method.

Further advantages arise by performing at least one calcination step and/or at least one crushing step after drying. Heat treatment is to be understood by calcination. For example, the calcination can be effected in a fixed bed or in a fluidized bed with dwelling times of a few seconds up to several hours. By calcination, depending on the used molybdenum and tungsten compounds, besides drainage, partial or complete oxidation or oxide formation can also be achieved as needed. In the fixed bed, different layer thicknesses are possible. By a crushing step, the surface of the mixed oxide and thereby its antimicrobial efficiency can be advantageously increased. The calcination step and the crushing step can basically be performed independently of each other once or several times in any order.

Therein, in further configuration of the invention, it has proven advantageous if the calcination step is performed under oxidizing and/or reducing atmosphere and/or under shielding gas and/or at temperatures between 150° C. and 1000° C. The calcination has influence on the specific surface of the mixed oxide as well as on the voids contained therein. Voids especially form in oxygen-deficient compounds and especially in presence of the monocline crystal structure in the mixed oxide. Basically, it can be said that higher calcination temperatures result in lower specific surfaces. At higher calcination temperatures, voids in the mixed oxide are partially removed, but partially new ones are also created. By a temperature between 150° C. and 1000° C., in particular temperatures of 150° C., 170° C., 190° C., 210° C., 230° C., 250° C., 270° C., 290° C., 310° C., 330° C., 350° C., 370° C., 390° C., 410° C., 430° C., 450° C., 470° C., 490° C., 510° C., 530° C., 550° C., 570° C., 590° C., 610° C., 630° C., 650° C., 670° C., 690° C., 710° C., 730° C., 750° C., 770° C., 790° C., 810° C., 830° C., 850° C., 870° C., 890° C., 910° C., 930° C., 950° C., 970° C., 990° C. or 1000° C. as well as corresponding intermediate temperatures such as for example 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C. and so on are to be understood. Usually, a calcination temperature in the range from 200° C. to 400° C. and/or a dwelling time of 0.5 to 4 hours has proven advantageous. Alternatively or additionally, it can be provided that the crushing step is performed by dry milling and/or by jet milling and/or up to an average grain size of the mixed oxide of 0.1 μm to 200 μm. By an average grain size of 0.1 μm to 200 μm, in particular grain sizes of 0.1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm and 200 μm as well as corresponding intermediate values such as for example 0.1 μm, 0.2 μm, 0.3 μm, 0.4 μm, 0.5 μm, 0.6 μm, 0.7 μm, 0.8 μm, 0.9 μm, 1.0 μm, 1.1 μm, 1.2 μm, 1.3 μm, 1.4 μm, 1.5 μm, 1.6 μm, 1.7 μm, 1.8 μm, 1.9 μm, 2.0 μm, 2.1 μm, 2.2 μm, 2.3 μm, 2.4 μm, 2.5 μm, 2.6 μm, 2.7 μm, 2.8 μm, 2.9 μm, 3.0 μm, 3.1 μm, 3.2 μm, 3.3 μm, 3.4 μm, 3.5 μm, 3.6 μm, 3.7 μm, 3.8 μm, 3.9 μm, 4.0 μm, 4.1 μm, 4.2 μm, 4.3 μm, 4.4 μm, 4.5 μm, 4.6 μm, 4.7 μm, 4.8 μm, 4.9 μm, 5.0 μm, 5.1 μm, 5.2 μm, 5.3 μm, 5.4 μm, 5.5 μm, 5.6 μm, 5.7 μm, 5.8 μm, 5.9 μm, 6.0 μm, 6.1 μm, 6.2 μm, 6.3 μm, 6.4 μm, 6.5 μm, 6.6 μm, 6.7 μm, 6.8 μm, 6.9 μm, 7.0 μm, 7.1 μm, 7.2 μm, 7.3 μm, 7.4 μm, 7.5 μm, 7.6 μm, 7.7 μm, 7.8 μm, 7.9 μm, 8.0 μm, 8.1 μm, 8.2 μm, 8.3 μm, 8.4 μm, 8.5 μm, 8.6 μm, 8.7 μm, 8.8 μm, 8.9 μm, 9.0 μm, 9.1 μm, 9.2 μm, 9.3 μm, 9.4 μm, 9.5 μm, 9.6 μm, 9.7 μm, 9.8 μm, 9.9 μm, 10.0 μm and so on are understood. The grain size or grain size distribution can basically be determined by laser diffraction or laser scattering. Usually, grain sizes of ≦5 μm have proven particularly advantageous. The mixed oxides can also be present as agglomerates of the individual grains. The grain size can also be indirectly determined via the specific surface, e.g. according to BET. Typical values are 0.5 to 5 m²/g. However, mixed oxides with considerably larger and considerably smaller specific surface have also proven antimicrobially effective.

Further advantages arise in that the at least one mixed oxide for producing a composite material is incorporated in at least one further material and/or is applied to the surface of the at least one further material. Hereby, the antimicrobial effect can be particularly flexibly provided for very different purposes of application. Within the scope of the invention, materials of two or more bound materials are understood by a composite material, wherein the at least one mixed oxide constitutes at least one of the materials. A composite material has other material characteristics than its individual components. For the characteristics of the composite material, material characteristics and geometries of the individual components are of importance. The form of the mixed oxides can be spherical, cylindrical, platelet-shaped and/or fibrous among other things. It results from the employed crushing method among other things. The bonding of the materials is preferably effected by adhesive bond or form fit or a combination of both. Especially polymers, silicones, plastics, paints, varnishes and ceramics can be antimicrobially configured with the mixed oxide. Typically, between 0.5 and 5% (mass) of the mixed oxide(s) are incorporated in the concerned material(s). Usual methods are for example compounding for plastics (extruder) and cutting in for paints and varnishes (dissolver). It is possible to incorporate 0.1 to 80% (mass) of the mixed oxide(s) in a carrier, either directly as a final product or as a concentrate for the further processing (so-called masterbatch).

A second aspect of the invention relates to a composite material for producing antimicrobially effective surfaces, wherein the composite material contains at least one doped and/or undoped mixed oxide according to the invention. The mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺. The composite material according to the invention thus allows improved antimicrobial configuration of items, which are partially or completely composed or produced of the composite material. Further features and the advantages thereof can be taken from the description of the first inventive aspect, wherein advantageous configurations of the first inventive aspect are to be regarded as advantageous configurations of the second inventive aspect and vice versa. The composite material according to the invention can basically be formed free of elementary molybdenum, MoO₂, MoO₃, molybdenum carbide, molybdenum nitride, molybdenum silicide or molybdenum sulfide, molybdenum hexacarbonyl, molybdenum acetylacetonate and/or molybdenum containing alloys. The same applies to elementary tungsten and the corresponding tungsten compounds and alloys. Similarly, the composite material can basically be formed free of not acid-forming metal oxides such as zinc oxide, titanium oxide, titanium dioxide, aluminum oxide or other not acid-forming protocatalysts. Furthermore, the composite material can basically be formed without the use of additional antimicrobially effective compounds such as for example silver, in particular nanosilver, or silver compounds, in particular soluble silver compounds such as silver nitrate and the like, copper, organic biocides, zeolites or the like, whereby considerable cost decreases and higher resistance are given besides better environmental compatibility of the composite material produced according to the invention.

In an advantageous configuration of the invention, it is provided that x is between 0.50 and 0.70 and/or that y is between 0.01 and 0.10 and/or that z is between 2.50 and 3.0 and/or that a molar W:Mo ratio is between 250:1 and 1:250, in particular between 3:1 and 1:3. Hereby, the at least one mixed oxide and thereby the composite material is particularly intensely antimicrobially effective.

In a further advantageous configuration of the invention, the composite material contains a mass fraction between 0.01% and 80%, in particular between 0.1% and 10% of mixed oxide related to its overall weight. For example, the composite material can therefore contain a fraction of 0.01%, 0.1%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79% or 80% or corresponding intermediate values of for example 0.01%, 0.1%, 0.2%, 0.3%, 0.4%, 0.5%, 0.6%, 0.7%, 0.8%, 0.9%, 1.0% and so on. Hereby, the antimicrobial efficiency can be optimally adapted to the respective purpose of employment of the composite material.

In further configuration of the invention, a particularly high antimicrobial efficiency is achieved in that the at least one mixed oxide is present in the form of particles having an average diameter between 0.1 μm and 200 μm, in particular between 0.5 μm and 10 μm.

Furthermore, according to the invention, it can be provided that the composite material includes at least one further material selected from a group including organic and inorganic polymers, plastics, silicones, ceramics, rubber, powder varnishes, liquid varnishes, bitumen, asphalt, glasses, waxes, resins, paints, textiles, fabrics, wood, composites, metals and hydrophilizing agents. In this manner, the composite material according to the invention can be particularly variably configured and be used for very different purposes of application. As organic polymers, in particular thermoplastic polymers such as for example polypropylene (PP), polyethylene (PE), polyethylene terephthalate (PET), polyvinylchloride (PVC), polystyrene (PS), polycarbonate (PC), a poly(meth)acrylate (e.g. PAA, PAN, PMA, PBA, ANBA, ANMA, PMMA, AMMA, MABS and/or MBS), acrylonitrile-butadiene-styrene (ABS), polyurethanes (PU), thermoplastic polyurethanes (TPU), thermoplastic elastomers (TPE), thermoplastic vulcanizates (TPV), polyoxymethylene (POM), polyethylene terephthalate (PET), epoxy resins, melamines and polylactic acid are to be mentioned. However, thermosetting polymers can also be provided as a matrix and/or substrate for the mixed oxide. As ceramic materials, in particular inorganic formulations containing the substances of aluminum oxide, titanium oxide, silicon oxide, silicon carbide and/or zirconium oxide are suitable. In order to be able to resort to the usual production methods and conditions for ceramics, mixed oxides present in the highest oxidation stage, that is in which the parameter z is between about 2.8 and 3.0, are suitable. A hydrophilizing agent increases the wettability of the surface of the composite material with water compared to the wettability of the surface of the composite material without addition of the hydrophilizing agent. For example, this can be measured via the contact angle of a water drop on the surface of the composite material. Surprisingly, contrary to the opinion in professional circles prevailing heretofore, it has turned out that the antimicrobial efficiency can be advantageously increased by forming the composite material not as hydrophobic as possible, but to the contrary hydrophilic by addition of an hydrophilizing agent. Therein, it can basically even be provided that the composite material is optionally slightly hygroscopic at least in the area of its surface. By hygroscopic, it is to be understood that the composite material absorbs humidity at least on its surface or in the areas near the surface. For example, the composite material should absorb between 0.01 and 10% by wt. of humidity in environments with 10% of relative humidity of the air. 0.1 to 3% equilibrium moisture content are particularly advantageous, which usually appear after a few minutes to hours. The addition of the hydrophilizing agent decreases the surface tension of the composite material and thus generates a more hydrophilic or more hygroscopic surface of the composite material. Therein, the invention is based on the realization that decreased antimicrobial efficiency occurs in particular in hydrophobic composite materials since these apolar composite materials do not contain or cannot bind humidity or only very little humidity on their surface. In contrast, the composite material according to the invention allows improved wetting of its surface with water such that more antimicrobially effective metals, metal ions and/or metal compounds can form or can be released depending on the respective agent. In that the composite material according to the invention includes one or more hydrophilizing agents besides the at least one mixed oxide, thus, the antimicrobial efficiency of the mixed oxide can be enhanced on the one hand and the amount of the employed mixed oxide can be lowered by up to 95% with the same or better antimicrobial efficiency on the other hand. Hereby, considerably cost savings as well as various further advantages arise since the amount of the metals or metal compounds contained in the composite material or released by the composite material can be advantageously decreased without loss of effect.

Although a covalent bonding of the hydrophilizing agent to a further material serving as a carrier agent is basically conceivable, the hydrophilizing agent(s) is or are preferably present non-covalently bound in the composite material, but is or are mixed with a carrier agent. Therein, the mixture of carrier agent and hydrophilizing agent can basically be homogeneous or single-phase or heterogeneous or multi-phase. The composite material according to the invention is also suitable for various purposes of employment, for which the composite materials known from the prior art could not be used heretofore. Suitable hydrophilizing agents are for example migrating additives, in particular glycerin monostearate, alginates, collagen, chitosan, gelatin, polyethylene glycol (PEG), polyethylene glycolester, polypropylene glycol (PPG), polypropylene glycolester, polycarboxylates, polyacrylic acids, polysaccharides, in particular starch and/or thermoplastic starch, polylactic acid (PLA), humic acids, lignin, maleic acid, erucic acid, oleic acid, stearates, silicagel, in particular fumed silica and/or zeolites, molasses, polydextrose, metal hydroxides, in particular Al(OH)₃ and/or Mg(OH)₂, aluminum oxide, in particular fused alumina, copolymers with acrylic acid, in particular copolymerizates from polystyrene and acrylic acid, acid anhydrides, in particular P₄O₁₀, and glycosaminoglycans, in particular heparin. Similarly, alkyl amine alkoxides, DMMB (dimethyl methylene blue) as well as further methylene blue derivatives have proven themselves. Among other things, organic acids such as behenic acid or isophthalic acid, antistatic agents, anti-fogging agents, lubricants, polyalcohols, gelatin, glycerin, alkylated amines, alkylated alkoxyamines and glycerin monostearates also function particularly well. Alkylated ethoxyamines are best suitable according to findings so far.

In a further advantageous configuration of the invention, it is provided that in addition to the doped and/or undoped mixed oxide, the composite material contains at least one molybdate and/or at least one tungstate and/or a compound of the chemical formula of Aⁿ⁺_{z}MO₄, in which M denotes Mo and/or W, A denotes at least one metal ion different from Mo and W and/or NH₄⁺ and n*z=+2. By the use of one or more of the mentioned compounds, besides good antimicrobial efficiency, particularly high light stability, in particular with respect to UV light, is surprisingly also achieved. Thus, the occurrence of undesired stains on the surface of the composite material produced according to the invention or of a component produced therefrom is particularly reliably prevented. Moreover, such molybdates and tungstates in particular in composite materials have particularly low water solubility and are at least substantially colorless or white. Hereby, the composite material according to the invention is particularly well suited for producing items, for which a neutral, white surface is desired. Conversely, due to the neutral white color of the surface, however, simple coloring by addition of corresponding dyes or color pigments can also be performed. Each molybdate or tungstate can basically be present in an amount between 0.1% by wt. and 80% by wt. in the composite material. Preferably, a final product produced from the composite material has between 0.5% by wt. and 5% by wt. of molybdates/tungstates at least in the area of its surface.

In further configuration of the invention, it has proven advantageous if A of the chemical formula Aⁿ⁺_{z}MO₄ is selected from a group including Na, K, Mg, Ca, Ag, Cu, Bi, V, Ti and Zn. Hereby, the solubility, the color and antimicrobial efficiency of the composite material can be optimally adapted to its respective purpose of employment. With the aid of the mentioned compounds individually and in any combination, in addition, the adhesion of microorganisms to the surface of the composite material can additionally be impeded. This particularly effectively prevents the colonization of the surface of the composite material. The mentioned molybdates and/or tungstates can be particularly fast, simply and inexpensively produced by collectively heating the corresponding carbonates, for example Na₂CO₃, ZnCO₃, CaCO₃ etc., with MoO₃ and/or WO₃ within the scope of solid synthesis. Alternatively, the mentioned molybdates and/or tungstates can be produced by dropwise adding solutions of corresponding nitrates, for example of ZnNO₃, Ag₂NO₃, CuNO₃ etc., in Na₂MoO₄ or Na₂WO₄ solutions and separating the precipitated reaction products.

In a further advantageous configuration of the invention, it is provided that the composite material contains at least one inorganic compound of the chemical formula of MO₃₋ₓ with M=Mo and/or W and 0≦x≦1 in addition to the doped and/or undoped mixed oxide. In other words, it is provided that in addition to the mixed oxide(s) at least one molybdenum oxide and/or tungsten oxide not present as a mixed crystal is used, wherein the concerned molybdenum and/or tungsten oxide is MoO₃ and/or WO₃, MoO₂ and/or WO₂ and/or an oxide deficient in oxygen with respect to MoO₃ and/or WO₃, the oxygen content of which is between that of MoO₃/WO₃ and MoO₂/WO₂. Accordingly, x can for example take values of 0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99 or 1.00 as well as all of the possible intermediate values. With the aid of these compounds individually or in any combination, a surface pH value as low as possible and thereby a particularly good antimicrobial efficiency are achieved in particularly simple and inexpensive manner since all of the mentioned compounds convert to molybdenic or tungstic acid and/or higher acidic oligomolybdates or oligotungstates upon contact with water. Moreover, in particular the compounds deficient in oxygen additionally have a comparatively high oxidation potential due to the different oxidation stages of Mo/W, that is substantially +IV, +V and/or +VI, magnetic characteristics and/or electrical conductivity, whereby additional antimicrobial effects can be achieved.

The compounds of the general formula of MO₃₋ₓ can be particularly simply and inexpensively produced by partial oxidation of M and/or MO₂ and/or by partial reduction of MO₃. In other words, the metals Mo/W and/or the dioxides MoO₂/WO₂ thereof can be partially oxidized to arrive at the compounds of the general formula of MO₃₋ₓ with x<1. Alternatively or additionally, the respective trioxides MoO₃ and/or WO₃ can be used as educts and be partially reduced to arrive at the compounds of the general formula of MO₃₋ₓ with 0<x<1.

The compounds of the above mentioned general formula of MO₃₋ₓ with 0≦x≦1 can for example be produced by means of a fluidized bed reactor and/or by chemical vapor deposition and/or by physical vapor deposition and/or by sputtering and/or in plasmaassisted manner and/or in a controlled atmosphere. The use of a fluidized bed reactor offers various advantages. On the one hand, the preferably particulate educts can be set in a fluidized state with a fluid in controlled manner, wherein for example a reaction gas or gas mixture can be used as the fluid, by means of which the partial oxidation and/or reduction can be performed. Alternatively or additionally, a desired reaction temperature can be adjusted via the fluid. Similarly, the fluidized educts can be guided past an energy source, for example a flame and/or a plasma source, for example in annular manner, by a corresponding fluid flow, whereby the contact time for the individual particles and thereby their degree of oxidation and reduction, respectively, can be particularly precisely adjusted. Similarly, the educt flow can be specifically mixed with a reactant or reactant mixture or be guided past a reactant flow. Furthermore, with the aid of the fluidized bed reactor, further functionalizations of the inorganic molybdenum and/or tungsten compounds can be performed in addition to the oxidation and reduction, respectively. For example, the molybdenum and/or tungsten compounds can be provided with a functional layer, for example a reactant layer, a hydrophilizing layer and the like before, during and/or after the oxidation and reduction, respectively. With the aid of chemical and/or physical vapor deposition, the composite material according to the invention can advantageously be immediately produced by coating the at least one further material directly with the molybdenum and/or tungsten containing compound. Corresponding advantages arise in a layer application by means of sputtering. Furthermore, it can be provided that the reaction is controlled by adjusting a controlled atmosphere. For example, reduction can occur in a controlled hydrogen atmosphere, while for example oxygen, ozone, hydrogen peroxide, chlorine and other oxidative compounds can be used individually or in any combination for adjusting oxidative conditions. However, wet-chemical production is basically also possible.

A third aspect of the invention relates to a use of a composite material according to the second inventive aspect and/or at least one doped and/or undoped mixed oxide for producing an item with an antimicrobially effective surface, wherein the mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺. The item is selected form a group including homewares, consumer goods, industrial appliances and components, ship paints, façade paints, tanks, cables, coatings, lines, pipes, components of petroleum exploration, petroleum production and petroleum storage, medical technology, food engineering, sanitary installations, packagings, textiles, furniture, building elements, pieces of furniture, clinics, counters, seats, keyboards and equipments of clinics, doctor's offices, care facilities, day nurseries, schools and publicly accessible buildings. The features arising therefrom and the advantages thereof can be taken from the descriptions of the first and the second inventive aspect. Therein, advantageous configurations of the first and the second inventive aspect are to be regarded as advantageous configurations of the third inventive aspect and vice versa. In particular, the mixed oxide can be produced by means of a method according to the first inventive aspect. Furthermore, the item or the product can for example be formed as an implant, catheter, stent, bone implant, dental implant, vascular prosthesis, endoprosthesis, exoprosthesis, cable, tube, food packaging, container, fuel tank, household product, counter, fitting, keyboard, mouse, joystick, housing, textile, thread, item of clothing, furniture and/or interior construction part, household appliance, credit card, mobile phone case, coin, bill, door handle, refrigerator, trickling material in the cooling tower, varnish coating, tile or a part of the internal fittings of a building or public service vehicle. Furthermore, it can be provided that the item is formed as a storage and transport container or as a line for hydrocarbons, fuels, solvents and organic liquids. Similarly, the composite material is suitable for producing items and products, which are in frequent tactile contact with living beings. A further advantageous use is in components for air conditioning systems. The cooling fins, which are usually composed of a Cu or Al alloy, can advantageously be coated with the composite material according to the invention or be produced of it. The ducts of air conditioning systems in buildings can also be antimicrobially configured by adding the composite material to the duct material, coating the duct material with it or by the duct material being composed of the composite material. Air humidifiers can also be provided with corresponding antimicrobial characteristics. In addition, the composite material can be used in cables and/or for producing cables.

In further configuration of the invention, the composite material is formed as a coating agent, in particular as a paint, varnish and/or antifouling paint. Embodiments of the composite material are understood by a paint, which have liquid to pasty consistency and which result in a physically or chemically drying paint applied to surfaces. Hereby, the advantageous characteristics of the composite material according to the invention can be particularly flexibly realized for any items and surfaces. Important configurations are for example antifouling paints, e.g. for ships, as well as antimicrobial configuration in the health system, the industry, the food sector and the private sector.

Further features of the invention are apparent from the claims, the embodiments as well as based on the drawings. The features and feature combinations mentioned above in the description as well as the features and feature combinations mentioned below in the embodiments are usable not only in the respectively specified combination, but also in other combinations without departing from the scope of the invention. There shows:

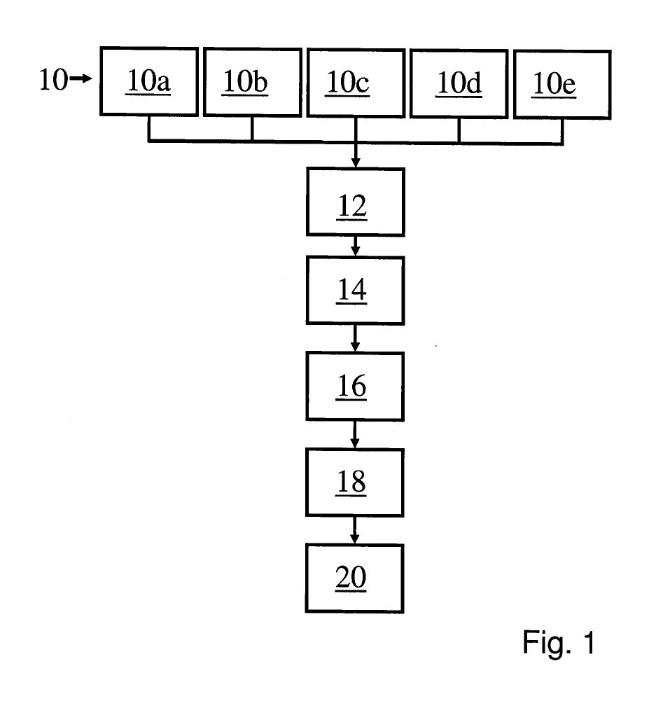

FIG. 1 a schematic flow diagram of a method according to the invention for producing a mixed oxide of the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺;

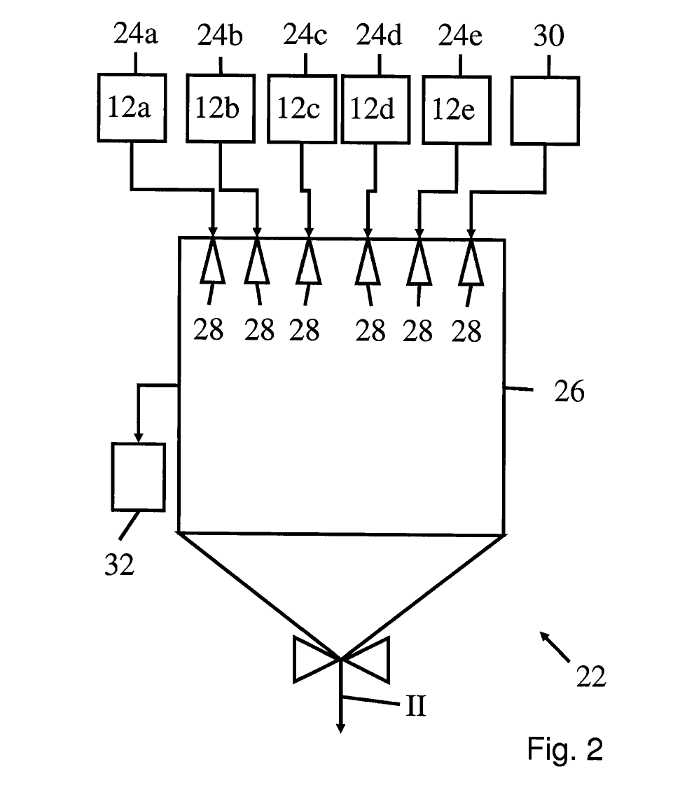

FIG. 2 a schematic diagram of a spray drying device;

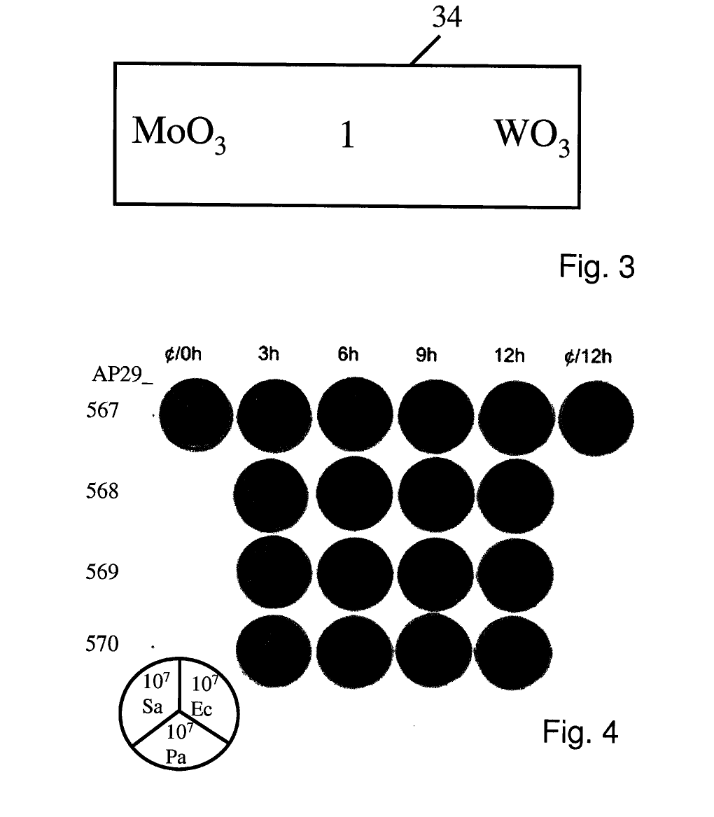

FIG. 3 a photograph of a glass plate with a continuous gradient of mixed oxides of the formula of MoₓW₁₋ₓO₃, wherein x=1 (MoO₃) on the left side and x=0 (WO₃): on the right side; and

FIGS. 4 to 6 photographs of several blood agar plates from test series for examining the antimicrobial efficiency of several composite materials according to the invention.

FIG. 1 shows a schematic flow diagram of a method according to the invention for producing doped and/or undoped mixed oxides of the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺. The production of these mixed oxides is effected in multiple partial steps. “Pure” mixed crystals only containing Mo, W, O and optionally voids in the crystal lattice can be produced. However, it is also possible to specifically mix or dope the mixed oxides with metals and metal ions, respectively, such as for example Cu, Bi, V and Zn. These metals are not directly incorporated in the crystal lattice due to their atomic radii different from Mo and W, but are present in the mixed oxide as molybdates and tungstates, partially also mixed, or as oxides.

In a first step 10, first, suitable molybdenum compounds 10a and tungsten compounds 10b and optionally further, basically optional educts such as for example zinc compounds 10c, bismuth compounds 10d and/or copper compounds 10e are provided. The molybdenum compounds 10a can for example include ADM, APM, MoO₂, MoO₃, MoO₃*x H₂O, POM (POM=polyoxometallate) and/or metallic molybdenum. The tungsten compounds 10b can for example include AMT, APT, WO₂, WO₃, WO₃*x H₂O, POM and/or metallic tungsten. Similarly, various further molybdenum and/or tungsten compounds such as for example the carbides, nitrides, silicides and sulfides thereof can basically be used since these compounds can also be converted to oxides. The zinc compounds 10c can for example include ZnO, salts as Zn(NO₃)₂ or metallic zinc. The bismuth compounds 10d can for example include Bi₂O₃, salts as Bi(NO₃)₃ or metallic bismuth. The copper compounds 10e can for example include CuO, salts as Cu(NO₃)₂ or metallic copper. For Zn, Bi, Cu and V, salts are particularly advantageous. Nitrate salts are usually best suitable because a disturbing anion (e.g. Cl⁻, SO₄²⁻) does not remain in an optionally subsequent calcination step. However, it is also possible to use pure metals, alloys or the oxides thereof, advantageously as a fine powder.

In a step 12, a liquid medium or multiple identical or different liquid media is or are provided to produce one or more solutions and/or suspensions of the provided educts. For example, polar solvents such as water, acetonitrile or alcohols are suitable as liquid mediums. Especially methyl alcohols have proven advantageous. Hydrocarbons are basically also suited. The solid content in the solution(s)/suspension(s) or the content of dissolved/suspended material can be between 0.1% and 90% (by mass) in each solution/suspension.

In a step 14, the solutions/suspensions are individually or collectively atomized (see FIG. 2). Some starting materials form a turbidity in pouring the solutions/suspensions together or in common preparation of a solution/suspension, for example zinc nitrate and ADM. In such cases, separate atomization of these substances is better.

Now, the formation of the mixed oxides can be effected according to different methods. Spray drying is particularly advantageous since this method is simple concerning apparatus and associated with low production cost. Freeze drying has also proven itself. The methods of combustion synthesis, flame hydrolysis, gaseous phase synthesis and spray pyrolysis are also possible. Flame-based methods have the advantage to generate particularly fine particles, the average grain sizes of which can be in the nanometer range. According to method and procedure, the mixed oxide or the mixed oxides arise in different grain size distributions and humidities.

In a basically optional step 16, the powder produced in step 14 is calcinated. Heat treatment at 150 to 1000° C. is to be understood thereby. For example, it can be effected in a fixed bed or in a fluidized bed. The dwelling times of the produced powders are in the range from few seconds up to several hours. Oxidizing or reducing conditions as well as shielding gas can be used. As the shielding gas, CO₂, argon or nitrogen have proven themselves. For oxidizing conditions, for example, air, oxygen, ozone, nitrogen dioxide or hydrogen peroxide can be used. For reducing conditions, carbon monoxide and hydrogen are well suited among other things. The calcination has an important influence on the specific surface of the powders as well as the voids contained therein. The higher the calcination temperature, the lower the specific surface of the mixed oxide becomes. Voids are partially removed, but also newly created. A calcination temperature in the range from 200 to 400° C. and a dwelling time of 0.5 to 4 hours are particularly advantageous, respectively.

In a basically optional step 18, the powder of step 14 and/or step 16 is crushed. Basically, the order of the steps 16 and 18 can be interchanged. Similarly, it is possible to perform the steps 16 and/or 18 multiple times or in any order. For crushing, different methods are possible. Dry milling is preferred, in particular by means of a ball mill or via jet milling. A grain size of 0.1 to 150 μm, measured via laser diffraction/laser scattering, has proven antimicrobially particularly effective. Grain sizes of at most 5 μm are particularly advantageous.

In a step 20, the mixed oxide is incorporated in materials, which are to be antimicrobially configured, or applied to the surface thereof to obtain a composite material. Especially plastics, paints, varnishes and ceramics can be particularly simply antimicrobially configured with the mixed oxides. Typically, related to the overall mass of the composite material, 0.5 to 5% (mass) of the mixed oxides are incorporated in the materials and/or applied to the materials. Suitable methods are for example compounding for plastics (extruder) and cutting in for paints and varnishes (dissolver). For the direct application to the surface, among other things, CVD, slip casting and sol-gel methods are suitable. It is possible to incorporate 0.1 to 80% (mass) of the mixed oxides in one or more materials, related to the overall mass of the composite material, either directly as a final product or as a concentrate for the further processing (so-called masterbatch).

FIG. 2 shows a schematic diagram of a spray drying device 22. The spray drying device 22 in number and arrangement exemplarily has 5 containers 24, which are denoted by the reference characters 24a-e for better discriminability, in which the solutions/suspensions 12a-12e produced in step 12 are received. Therein, 12a denotes the solution/suspension of the molybdenum compound(s) 10a, 12b denotes the solution/suspension of the tungsten compound(s) 10b, 12c denotes the solution/suspension of the zinc compounds 10c, 12d denotes the solution/suspension of the bismuth compounds 10d and 12e denotes the solution/suspension of copper compounds 10e. Optionally possible vanadium and titanium compounds are not illustrated in this graphics, but can be employed additionally or alternatively to the other mentioned compounds. The individual solutions/suspensions 12a-12e can be introduced into a drying space 26 of the spray drying device 22 independently of each other. Hereto, the containers 24a-e are fluidly coupled to corresponding nozzles 28. Besides the supply of the individual solutions/suspensions via individual lines and nozzles 28, they can be previously combined and introduced into the spray drying chamber via a common line and nozzle 28. Further, it is possible to directly perform the mixing of the solutions in a special multi-substance nozzle (not shown) immediately before atomization. Via a basically optional supply 30, further compounds, in particular gases or gas mixtures, can be introduced into the drying space 26, for example to provide oxidizing or reducing reaction conditions. Similarly, shielding gases can be introduced. The liquid medium or the liquid media are removed from the drying space 26 via the negative pressure device 32 during the process. The dried product(s) fall downwards caused by gravity and can be removed via corresponding removal systems from the drying space 26 according to arrow II. The spray drying device 22 can be combined with a crushing device (not shown) and/or a calcination device (not shown) as desired.

FIG. 3 shows a photograph of a glass plate 34 with a continuous gradient of mixed oxides of the formula of MoₓW₁₋ₓO₃. Here, the production was effected via PVD. On the left side of the glass plate 34, there is present pure MoO₃ (x=1), and on the right side of the glass plate 34 there is pure WO₃ (x=0). In the middle of the glass plate 34, there is x=0.5, such that a mixed oxide of the chemical formula of Mo_{0.5}W_{0.5}O₃ is present. In this manner, it is particularly simply possible to perform screening according to the most effective mixing ratios.

The metals copper, vanadium, bismuth, titanium and zinc can also be present as molybdates/tungstates, oxides and/or bronzes. Bronzes are interstitial compounds (intercalation compounds). They only have the name in common with the classical “bronze”, a Cu—Sn alloy. In molybdenum and tungsten, the name bronze stands for a plurality of compounds, specifically tungsten bronzes MₓWO₃ (0<x<=1) and molybdenum bronzes MₓMoO₃ (0<x<=1)=monovalent, but also higher valent metal, but also NH₄⁺). The name “bronzes” was selected because the color of these compounds varies depending on x over a large range. Very marvelous tints are among them. The ratio (W+Mo):O is at about 1:3. Cubic, tetragonal and hexagonal bronzes exist. The realizable limit composition is determined by the size of the cation and the structural type. An example is the cubic NaₓWO₃. In this case, x can reach the value of 1. In the following, 6 classes of substances of mixed oxides, wherein the term “mixed oxide” is used synonym with “mixed crystal”, even if it is an amorphous or partially amorphous material, are discussed in more detail. The 6 classes of substances are listed in the table 1 below. The respective content of the individual components is indicated in mole-%, knowing well that mass percent are more comfortable for practical handling (weighing out, mixing etc.).

TABLE 1
Composition of the MoₓW₁₋ₓO_{z} mixed oxides doped with Zn/Bi/Cu (indications
in mole-% of the elements)

| | MoₓW₁₋ₓM_{y}O_{z} | MoₓW₁₋ₓM_{y}O_{z} | | | | |
|---|---|---|---|---|---|---|
| | with M = Zn, | with M = Zn, | MoₓW₁₋ₓM_{y}O_{z} | MoₓW₁₋ₓM_{y}O_{z} | MoₓW₁₋ₓM_{y}O_{z} | |
| Compound | Bi, Cu | Bi | with M = Zn | with M = Bi | with M = Cu | MoₓW₁₋ₓO_{z} |
| Fraction W | (0.98-0.90) · (25-75) | | | | | 25-75 |
| Fraction | (0.98-0.90) · (25-75) | | | | | 25-75 |
| Mo | | | | | | |
| Fraction | 2-10 | 2-10 | 2-10 | | | |
| Zn | | | | | | |
| Fraction Bi | | | | 2-10 | | |
| Fraction | | | | | 2-10 | |
| Cu | | | | | | |
| Contained | MoₓW₁₋ₓM_{y}O₃ | MoₓW₁₋ₓM_{y}O₃ | MoₓW₁₋ₓM_{y}O₃ | MoₓW₁₋ₓM_{y}O₃ | MoₓW₁₋ₓM_{y}O₃ | MoₓW₁₋ₓM_{y}O₃ |
| compound | mixed crystal | mixed crystal | mixed crystal | mixed crystal | mixed crystal | mixed |
| | doped | doped | doped | doped | doped | crystal |
| | with Zn, Bi | with Zn and | with Zn | with Bi | with Cu | |
| | and Cu | Bi tungstates/ | tungstates/ | tungstates/ | tungstates/ | |
| | tungstates/ | molyb- | molyb- | molyb- | molyb- | |
| | molyb- | dates | dates | dates | dates | |
| | dates | | | | | |

The possibility of doping Cu with vanadium (V) and/or titanium (Ti) or other metals (M) in addition to or instead of Zn, Bi or Cu, is not presented in table 1, but is also possible. W—Mo mixed oxides have proven particularly advantageous, which had a molar W:Mo ratio of 3:1, 1:1 and 1:3. However, it is also possible to vary the ratio of Mo:W and of W:Mo in the range of 1:250, respectively.

The compounds produced according to the invention as well as the composite materials according to the invention have an excellent antimicrobial efficiency. FIG. 4 to FIG. 6 each show photographs of several blood agar dishes from test series for examining the antimicrobial efficiency of composite materials according to the invention. The blood agar dishes each were provided with a blood agar plate, which were divided into three sectors with respectively different bacterial tests. The experiments have been effected according to the graft method with the three germs of E.c., S.a. and P.a. In the graft method, a drop containing 10⁵-10⁹ CFU/ml of germs of for example 100 μl is respectively applied to an antimicrobial specimen. Every 3 hours, for example 10 μl are extracted from the drop and distributed on the agar plate divided in thirds and subsequently incubated at 37° C. for 10-24 hours. The more germs are subsequently visible on the agar plate, the more germs still exist in the drop on the specimen. Besides this graft method, in particular, the method of rolling culture has well proven for examining the antimicrobial effect of composite materials (not illustrated here). Therein, the examined composite materials are placed in corresponding germ suspensions in the form of a cylinder for examining their antimicrobial efficiency. Superficial growth of germs occurs. After 3, 6, 9 and 12 hours, the samples are rolled over an agar plate and placed in a sterile, physiological sodium chloride solution in between. After this rolling operation, the agar plates or Petri dishes are incubated at 37° C. for 10-24 hours in order that the germs transmitted from the specimen grow and can be visualized. The agar plates are photographed and assessed with respect to the germ reducing or germ killing effect of the concerned composite material. This repeated rolling action in 3 hour interval indicates if and with which degree of efficiency a germ reducing or germ killing effect occurs. The rolling method also captures the reduction of the adherence of germs to surfaces. It is particularly well suited to assess contact biocides, whereas methods as inhibition zone testing are preferably suitable for effective systems containing migrating substances or having to release ions or organic compounds such as silver. The effective mechanism of the mixed oxides is similar as in MoO₃ and WO₃ and thereby a phenomenon directly on the surface or the interface of the concerned composite material, where the pH value is decreased, while the pH value of a solution above is not notably changed. Besides the pH value decrease at the surface, the antimicrobial efficiency of the mixed oxides or the mixed oxides incorporated in materials relies on further effects, including on electrostatic interactions between the mixed oxides and the cell walls of the germs. Usually, these interactions are the more intense, the larger the specific surface of the mixed oxides and/or the density of their voids or vacancies is. The rolling method can be applied for the examination of various microorganisms. The examinations for prove of effect of the composite materials according to the invention have been effected separately for the reference strains of Staphylococcus aureus (S.a., suspension with 10⁷ CFU/ml (colony forming units per milliliter)), Escherichia coli (E.c., suspension with 10⁷ CFU/ml) and Pseudomonas aeroginosa (P.a., suspension with 10⁷ CFU/ml).

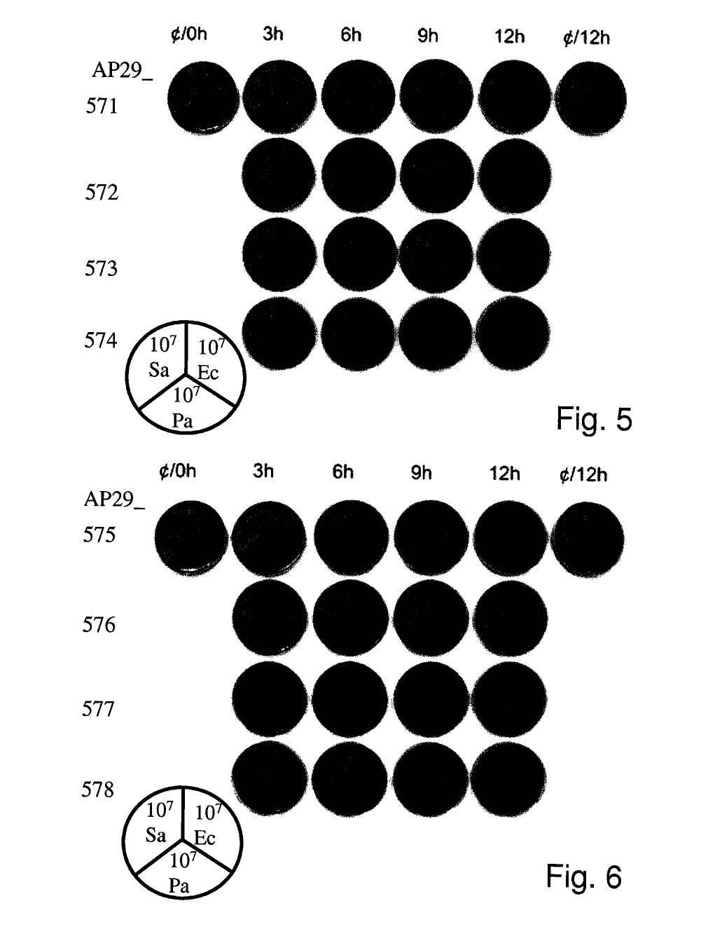

Table 2 reproduces the composition and production details of the composite materials tested in FIG. 4 to FIG. 6 containing mixed oxides produced according to the invention of the general formula of MoₓW₁₋ₓO_{z} with z=2.8 to 3.0. Therein, TPU1180A denotes a thermoplastic polyurethane, which is for example obtainable under the trade name Elastollan 1180A at BASF. However, the antimicrobial efficiency of the compounds has been proven in further plastics such as PP, PE, PC, PS, ABS, PVC as well as silicone, powder varnish, liquid varnishes, epoxy resin and other materials in similar characteristic. Especially in apolar materials, by additionally incorporated hydrophilizing agents (humectants), increase of the antimicrobial efficiency could be presented. Besides, together with the mixed oxide, TiO₂ can also be employed. In FIG. 4 to FIG. 6, control samples identified by Ø without antimicrobial configuration are additionally also presented. These control samples were prepared at the beginning and at the end of the test to show that the germs do not die by themselves over the duration of the experiment.

| | | | Molar | | |
|---|---|---|---|---|---|
| | | | ratio | | |
| No. | Composition | FIG. | Mo:W | Powder | Calcinated |
| AP29_567 | TPU1180A + 2% | FIG. 4 | 1:1 | fine | 300° C. |
| | mixed oxide | | | | |
| AP29_568 | TPU1180A + 2% | FIG. 4 | 1:1 | coarse | 300° C. |
| | mixed oxide | | | | |
| AP29_569 | TPU1180A + 2% | FIG. 4 | 1:1 | fine | 400° C. |
| | mixed oxide | | | | |
| AP29_570 | TPU1180A + 2% | FIG. 4 | 1:1 | coarse | 400° C. |
| | mixed oxide | | | | |
| AP29_571 | TPU1180A + 2% | FIG. 5 | 1:3 | fine | 300° C. |
| | mixed oxide | | | | |
| AP29_572 | TPU1180A + 2% | FIG. 5 | 1:3 | coarse | 300° C. |
| | mixed oxide | | | | |
| AP29_573 | TPU1180A + 2% | FIG. 5 | 1:3 | fine | 400° C. |
| | mixed oxide | | | | |
| AP29_574 | TPU1180A + 2% | FIG. 5 | 1:3 | coarse | 400° C. |
| | mixed oxide | | | | |
| AP29_575 | TPU1180A + 2% | FIG. 6 | 3:1 | fine | 300° C. |
| | mixed oxide | | | | |
| AP29_576 | TPU1180A + 2% | FIG. 6 | 3:1 | coarse | 300° C. |
| | mixed oxide | | | | |
| AP29_577 | TPU1180A + 2% | FIG. 6 | 3:1 | fine | 400° C. |
| | mixed oxide | | | | |
| AP29_578 | TPU1180A + 2% | FIG. 6 | 3:1 | coarse | 400° C. |
| | mixed oxide | | | | |

As one recognizes in FIG. 4 to FIG. 6, all of the samples had an excellent antimicrobial efficiency such that at the latest after 12 h an extensive or complete germ killing occurred. For a particularly high antimicrobial efficiency, in practice, weight proportions of 0.05 to 15% (by mass) of the mixed oxides produced according to the invention in plastics, paints, varnishes and ceramic have proven advantageous. A concentration range of 0.5 to 5% by mass, in particular 1-3%, is particularly advantageous.

Further mixed oxides tested for their antimicrobial efficiency in the above mentioned manner and found particularly well effective had the general chemical formula of MoₓW₁₋ₓO_{z} with 0.64≦x≦0.68 and 0.27≦z≦3.0, for example Mo_{0.66}W₀₃₄O₃.

In coating surfaces e.g. with the aid of physical (PVD) or chemical (CVD) vapor deposition methods, the surface of the composite material can contain up to 100% of the mixed oxide. Of plastics, paints and varnishes, concentrates (masterbatches) with 15% to 95% (by mass) of mixed oxide can also be produced in a carrier, which are again diluted later for producing the actual product. The following materials can for example be antimicrobially configured by adding the mixed oxides described here: polymers and plastics, among them the thermoplastics PE, PP, PC, ABS, PS, PU, PVC, PET and POM, elastomers, duroplasts, the substances TPU, TPE, TPV, polylactic acid, silicone, powder varnishes, liquid varnishes, ceramic, melamine, methylacrylate, wood, epoxy resin, waxes, emulsions and liquid and solid detergents and disinfectants. In the latter, by addition of the mixed oxides, remanence (increase of the duration of effect) as well as increase of the efficiency can be achieved. For further increasing the antimicrobial efficiency, the composite material to be configured can additionally be hydrophilized. This is for example possible by addition of a humectant, antistatic agent, anti-fog agent and/or a surfactant.

The mixed oxides according to the invention of the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺, in summary have the following advantages with regard to the antimicrobial configuration of composite materials with respect to pure MoO₃ and pure WO₃, with respect to mixtures of pure MoO₃ and pure WO₃, as well as with respect to usual antimicrobial active ingredients:
Very low solubility in water, alcohols and other solvents
Very low toxicologic potential, no indications of carcinogenicity
Low inherent coloration, well overdyeable
Cost saving since the same antimicrobial effect can be achieved with less dosage than with MoO₃ and WO₃.
Wider action spectrum

The following positive effects observed already in the system of pure MoO₃ and pure WO₃ or in macroscopic mixtures of MoO₃ and WO₃ for antimicrobial configuration also show themselves in the mixed oxides according to the invention:
Robustness in the practical employment. No inactivation by sulfur containing compounds, albumen, proteins and sweat.
Long lasting, strong efficiency against a wide spectrum of germs: bacteria, viruses, fungi and algae.
Also effective against antibiotic resistant germs, among them multi-resistant germs such as MRSA, ESBL, VRE and legionella.

Without desiring to be fixed to the following theories, the inventors assume that the antimicrobial efficiency of the new mixed oxides is based on several effects, partially in differently severe peculiarity, which are enumerated here:
Formation of acidic centers or acidic surfaces upon contact with water
Destabilization of the cell walls or germs by electrostatic interactions (zeta potential, density of voids or charges/free valences on the surface)
Oligodynamic effect

Especially in presence of zinc, a photo effect has been additionally observed.

In a further embodiment, in addition to the mixed oxide(s), the molybdates/tungstates CaMO₄, ZnMO₄, BiMO₄, VMO₄, CuMO₄ and Ag₂MO₄ with M=Mo, W, are used individually or in any combination and incorporated in a composite material. The production of these molybdates/tungstates is effected by intimately mixing MoO₃ and/or WO₃ with the corresponding carbonates and heating to temperatures of about 400° C. to 800° C. Therein, different carbonates can basically also be used to obtain corresponding mixed molybdates or mixed tungstates. The reaction can be driven towards the desired products by removing the arising CO₂ from the reaction mixture. As soon as carbonate is no longer detectable, the conversion has been completely effected. The mentioned compounds also show particularly high light and UV stability besides good antimicrobial effect. The test of the UV resistance can be performed in accordance with DIN EN 438-2, section 27. Herein, a sample of a composite material is produced by bonding one or more of the mentioned molybdates and tungstates, respectively, to one or more mixed oxides and at least one further material to a composite material. Therein, the molybdates and tungstates, respectively, as well as the mixed oxides can be present as a layer or component of a layer and/or be present distributed in the at least one further material. The composite material is exposed to irradiation for 60 minutes. The same is effected with a comparative sample (“standard product”) produced in analogous manner, but without addition of the mentioned molybdenum/tungsten compounds. The evaluation is then effected based on a visual comparison of the antimicrobially configured and the non-configured sample and is for example evaluated as follows:

1: no perceivable difference to the standard product
2: hardly perceivable difference to the standard product
3: uniquely perceivable difference to the standard product
4: just acceptable difference to the standard product
5: non-acceptable difference to the standard product

For composite materials, which also contain molybdates/tungstates besides mixed oxides, therein, values of 1 or at most 2 are always obtained.

In a further embodiment, the composite material additionally contains besides 2% by wt. of mixed oxide(s) between 0.1% by wt. and 2% by wt. of compounds of the general formula of MO₃₋ₓ with 0<x<1 and M=W, Mo. Hereto, MoO₂ and WO₂ have been partially oxidized individually or in certain mixing ratios. The resulting oxides or mixed oxides, respectively, also had excellent antimicrobial characteristics if they were present in the composite material together with mixed oxide(s).

As materials or matrix for the production of the composite material, basically, thermoplastic or thermosetting plastics, paints, varnishes, silicones, rubber, caoutchouc, melamine, acrylates, methacrylates, waxes, epoxy resins, glass, metal, ceramic and further are for example possible. The material, in which the molybdenum and tungsten compound(s), respectively, is or are incorporated for the purpose of antimicrobial configuration, can form a solid and/or liquid matrix. It can be provided that the molybdenum and tungsten compounds, respectively, are added such that they constitute between 0.1% and 10% (percent by weight or volume) of the overall weight or overall volume. Furthermore, it can be provided that the molybdenum and tungsten compounds, respectively, are used in particulate form with average particle sizes between 0.1 μm and 100 μm.

For example, the at least one further material can include hydrophobic polymers such as silicones, polypropylene (PP), acrylonitrile-butadiene-styrene (ABS), polycarbonate (PC) or polystyrene (PS) or be composed thereof. Phenolic resins, phenolformaldehyde resins, melamine resins, melamine formaldehyde resins, urea resins, ureaformaldehyde resins and polymeric diphenylmethane diisocyanate as well as any mixtures thereof can also be provided. Furthermore, the composite material can include polyethylene (PE), polyethylene terephthalate (PET), polyvinylchloride (PVC), polystyrene (PS), polycarbonate (PC) or a poly(meth)acrylate (e.g. PAA, PAN, PMA, PBA, ANBA, ANMA, PMMA, AMMA, MABS and/or MBS) as further material. The use of thermoplastic elastomers allows the production of surfaces with rubbery-elastic characteristics, in which the at least one molybdenum/tungsten containing compound is received or retained. The thermoplastic elastomer(s) can for example belong to the classes of TPO, TPV, TPU, TPC, TPS or TPA or any mixtures herefrom, wherein in particular thermoplastic elastomers based on urethane (TPUs) have proven advantageous. The use of a reactive varnish allows the production of mechanically particularly resistant surfaces, wherein the reactive varnish preferably already cures at room temperature by chemical reaction. Basically, the reactive varnish can be present or be used as a one- or multi-component varnish. Similarly, the composite material can basically be formed as a UV-curable varnish, acrylic varnish and/or silicone containing varnish. In the case of the configuration as an UV curable varnish, the additional use of light and UV stabile molybdenum/tungsten containing compounds has proven advantageous to avoid stains. To the contrary, however, light and UV labile molybdenum/tungsten containing compounds can also be used and be converted at the same time with the curing of the varnish. Composite material varnishes based on silicone have the advantage of a very low change of their film volume during curing due to their low portion of organic groups. Hereby, very dense layers with good film strength can be generated, in which the at least one molybdenum/tungsten containing compound is absorbed or retained. Moreover, silicone varnishes have a high thermal resistance and therefore are suitable for coating items, which are provided for use in the area of heat sources.

The composite material can be used for producing very different products and items. The product can for example be formed as an implant, catheter, stent, bone implant, dental implant, vascular prosthesis, endoprosthesis, exoprosthesis, cable, tube, food packaging, container, fuel tank, household product, counter, fitting, keyboard, mouse, joystick, housing, textile, thread, item of clothing, furniture and/or interior construction part, household appliance, credit card, mobile phone case, coin, bill, door handle, refrigerator, trickling material in the cooling tower, varnish coating, tile or a part of the internal fittings of a building or public service vehicle. Furthermore, it can be provided that the composite material or the item is formed as a storage and transport container or as a line for hydrocarbons, fuels, solvents and organic liquids. Similarly, the composite material according to the invention can be used for producing an item from the group of homewares, medical technology, food engineering, sanitary installations, packagings, textiles, clinics, counters, seats and keyboards. Similarly, it is suitable for products, which are in frequent tactile contact with living beings. A further advantageous use is in components for air conditioning systems. The cooling fins, which are usually composed of a Cu or Al alloy, can advantageously be coated with the cornposite material according to the invention or be produced of it. The ducts of air conditioning systems in buildings can also be antimicrobially configured by adding the composite material to the duct material, coating the duct material with it or by the duct material being composed of the composite material. Air humidifiers can also be provided with corresponding antimicrobial characteristics. In addition, the composite material can be used in cables and/or for producing cables.

In further configuration of the invention, the composite material is formed as a coating agent, in particular as a paint, varnish and/or antifouling paint. Embodiments of the composite material are understood by a paint, which have liquid to pasty consistency and which result in a physically or chemically drying paint applied to surfaces. Hereby, the advantageous characteristics of the composite material according to the invention can be particularly flexibly realized for any items and surfaces. Important configurations are for example antifouling paints, e.g. for ships, as well as antimicrobial configuration in the health system, the industry, the food sector and the private sector.

In a further embodiment, at least the surface of the composite material is hydrophilized. Here, hydrophilizing agents (e.g. Irgasurf™ HL560, TechMer PPM15560™, Bayhydur™ 304) as they are employed for PP textile fibers are particularly advantageous. Alternatively or additionally, polyethylene glycol (PEG, PEG400), the derivatives thereof, hyaluronic acid, starch, oxyethylated carbonic acid compounds, hydrophilic silicates, atmer, saccharose methacrylates, hydrophilized, aliphatic polyisocyanate based on hexamethylene diisocyanate (HDI) as well as diverse fibers and GMS (glycerin monostearate) as well as the derivatives thereof are suitable. Further substances for providing hydrophilic characteristics are fatty alcohol phosphates as well as derivatives of polyethylene oxide (PEO), in particular with hydroxyl end groups.

By hygroscopic, it is to be understood that the composite material absorbs humidity at least on its surface or in the areas near the surface. For example, the composite material should absorb between 0.01 to 10% by wt. of humidity in environments with <10% of relative humidity of the air. 0.1 to 3% of equilibrium moisture content are particularly advantageous, which usually appear after a few minutes to hours.

The parameter values specified in the documents for defining process and measurement conditions for the characterization of specific characteristics of the inventive subject matter are to be considered as encompassed by the scope of the invention even within the scope of deviations—for example due to measurement errors, system errors, weighing errors, DIN tolerances and the like.

1. Method for producing a doped or undoped mixed oxide for a composite material, wherein the mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺, in which at least the steps of:
dissolving and/or suspending at least one molybdenum compound and at least one tungsten compound in at least one liquid medium;
mixing the at least one molybdenum compound and the at least one tungsten compound in a predetermined mass ratio; and
drying the mixture of the at least one molybdenum compound and the at least one tungsten compound are performed.

2. Method according to claim 1,
wherein
the at least one molybdenum compound is selected from a group including ammonium dimolybdate (ADM), ammonium paramolybdate (APM), ammonium pentamolybdate, ammonium heptamolybdate, molybdenic acid, molybdenum oxihydrate, molybdenum oxide, molybdenum suboxide, metallic molybdenum and polyoxomolybdates and/or that the at least one tungsten compound is selected from a group including ammonium metatungstate (AMT), tungstic acid, tungsten oxihydrate, tungsten oxide, tungsten suboxide, metallic tungsten and polyoxotungstates.

3. Method according to claim 1,
wherein
M is selected from the group of Na, Cu, Bi, V, Ti and Zn and/or that the mixed oxide is doped with a fluorine compound, in particular with an oxyfluoride, WOF₄, WO₂F₂, calcium fluoride and/or fluorapatite.

4. Method according to claim 1,
wherein
the liquid medium is selected from a group including nonpolar and/or polar and/or protic and/or aprotic solvents.

5. Method according to claim 1,
wherein
the solution and/or suspension of the at least one molybdenum compound and the at least one tungsten compound are dried with the aid of at least one method from the group of spray drying, freeze drying, combustion synthesis, flame hydrolysis, gaseous phase synthesis and/or spray pyrolysis.

6. Method according to claim 1,
wherein
after drying, at least one calcination step and/or at least one crushing step are performed.

7. Method according to claim 6,
wherein
the calcination step is performed under oxidizing and/or reducing atmosphere and/or under shielding gas and/or at temperatures between 150° C. and 1000° C. and/or that the crushing step is performed by dry milling and/or by jet milling and/or up to an average grain size of the mixed oxide of 0.1 μm to 200 μm.

8. Method according to claim 1,
wherein
the at least one mixed oxide is incorporated in at least one further material and/or is applied to the surface of the at least one further material for producing a composite material.

9. Composite material for producing antimicrobially effective surfaces containing at least one doped and/or undoped mixed oxide, wherein the mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺.

10. Composite material according to claim 9,
wherein
that x is between 0.50 and 0.70; and/or
that y is between 0.01 and 0.10; and/or
that z is between 2.50 and 3.0; and/or
that a molar W:Mo ratio is between 250:1 and 1:250, in particular between 3:1 and 1:3.

11. Composite material according to claim 9,
wherein
it contains a mass fraction between 0.01% and 80%, in particular between 0.1% and 10% of mixed oxide related to its overall weight.

12. Composite material according to claim 9,
wherein
the at least one mixed oxide is present in the form of particles with an average diameter between 0.1 μm and 200 μm, in particular between 0.5 μm and 10 μm.

13. Composite material according to claim 9,
wherein
it includes at least one further material, which is selected from a group including organic and inorganic polymers, plastics, silicones, ceramics, rubber, powder varnishes, liquid varnishes, bitumen, asphalt, glasses, waxes, resins, paints, textiles, fabric, wood, composites, metals and hydrophilizing agents and/or an oxide of Zn, Bi, Cu, Ti and/or V.

14. Composite material according to claim 9,
wherein
it contains additionally to the doped and/or undoped mixed oxide at least one molybdate and/or at least one tungstate and/or a compound of the chemical formula of Aⁿ⁺_{z}MO₄, in which M denotes Mo and/or W, A denotes at least one metal ion different from Mo and W and/or NH₄⁺ and n*z=+2.

15. Composite material according to claim 14,
wherein
A is selected from a group including Na, K, Mg, Ca, Ag, Cu, Bi, V, Ti and Zn.

16. Composite material according to claim 9,
wherein
it contains additionally to the doped and/or undoped mixed oxide at least one inorganic compound having the chemical formula of MO₃₋ₓ with M=Mo and/or W and 0≦x≦1.

17. Use of a composite material according to claim 9 and/or at least one doped and/or undoped mixed oxide for producing an item with an antimicrobially effective surface, wherein the mixed oxide has the chemical formula of MoₓW₁₋ₓM_{y}O_{z}, in which there is 0<x<1, 0≦y≦2 and 2.0≦z≦3.0 and M denotes a metal ion different from Mo and W and/or NH₄⁺, and wherein the item is selected from a group including homewares, consumer goods, industrial appliances and components, ship paints, façade paints, tanks, cables, coatings, lines, pipes, components of petroleum exploration, petroleum production and petroleum storage, medical technology, food engineering, sanitary installations, packagings, textiles, furniture, building elements, pieces of furniture, clinics, counters, seats, keyboards and equipment of clinics, doctor's offices, care facilities, day nurseries, schools and publicly accessible buildings.
